(19) United States
(12) Patent Application Publication
(10) Pub. No.: US 2011/0165869 A1
(43) Pub. Date: Jul. 7, 2011

(54) Apparatus and Methods Thereof for Effective Exporting of Services from an Old User Device to a New User Device

(75) Inventor: Noam Guzman, Tel Aviv (IL)

(73) Assignee: RETALIKA, LTD., Tel-Aviv (IL)

(21) Appl. No.: 12/651,579

(22) Filed: Jan. 4, 2010

(51) Int. Cl. H04W 8/00

(52) U.S. Cl. 455/418

(57) ABSTRACT

A method for enabling service transfer from a first mobile device to a second mobile device. the method comprises identifying the first mobile device model; identifying the second mobile device model; retrieving a list of services installed on the first mobile device; accessing a two-dimensional matrix contained in a database, wherein the two-dimensional matrix includes a plurality of services in a first dimension of the matrix and a plurality of mobile device models in a second dimension of the matrix, and containing an indication of compatibility of at least one service of the plurality of services to at least a mobile device model of the plurality of mobile device models; determining using the compatibility indication which of the services in the list of services are compatible with second mobile device; and installing an executable code of each of the compatible service on the second mobile phone.

### TECHNICAL FIELD

The invention generally relates to the field of mobile devices installed with one or more services, and more particularly with exportation of services from one mobile device to another.

### BACKGROUND OF THE INVENTION

Mobile devices, such as personal digital assistants (PDAs) and cellular phones, have become common place in the last decade and a half. The advances in the capabilities of such devices enable beyond the telephony features to equip the mobile device with a slew of services that make the use of the mobile device more convenient and attractive to its user. A typical user of modern days' mobile devices may have a relatively large number of services installed on the mobile device. Examples for such services are applications (apps) that can installed on iPhone and Blackberry® devices.

The advances in mobile devices are rapid and therefore users frequently upgrade or otherwise change their old mobile device by a new one. This happens frequently and is encouraged by both service provides as well as by the users who want to take advantage of the more advanced features that newer mobile devices may provide. Loss of a phone results in loss of a variety of important information and services from the lost mobile device. Several backup solutions are made available to the user. However, the challenge begins when the old mobile device must be replaced by another, new mobile device, the compatibility of which to the old mobile device being generally unknown. Thus, the transfer from one mobile device to another does not come without some significant challenge, regardless if backup exists.

A common place occurrence is the user's requirement to transfer the user's contact list that these days may include hundreds of phone numbers and other information. In some cases this becomes challenging due to incompatibilities between the old mobile device and the new mobile device. Devices for transferring of data from a source mobile device to a target mobile device do exist. However, such devices do not address the issue of services installed on the source mobile device, due to the complexity of the transfer of executable code generally associated with the services installed.

The transfer problem is further magnified when the user want to transfer the services installed on the old mobile device to the new mobile device. Not only is it a pain to the users but also to providers of the services as well as the retailers attempting to provide a painless and effective service when a user moves from one mobile device to another. The providers of services fear that at the mobile device change opportunity a user maybe inclined to drop the service they provided in favor of another one, especially if the transfer process is not straightforward. This is of particular concern when an executable code is installed on the old mobile device which may not be possible to be transferred in this format to the new mobile device.

There is therefore a clear need in the art for a solution for efficient and effective export of services installed on one mobile device to another mobile device.

### SUMMARY OF THE INVENTION

Certain embodiments of the invention include a method for enabling service transfer from a first mobile device to a second mobile device. The method comprises identifying the first mobile device model; identifying the second mobile device model; retrieving a list of services installed on the first mobile device; accessing a two-dimensional matrix contained in a database, wherein the two-dimensional matrix includes a plurality of services in a first dimension of the matrix and a plurality of mobile device models in a second dimension of the matrix, and containing an indication of compatibility of at least one service of the plurality of services to at least a mobile device model of the plurality of mobile device models; determining using the compatibility indication which of the services in the list of services are compatible with second mobile device; and installing an executable code of each of the compatible service on the second mobile phone.

Certain embodiments of the invention include a system for enabling service transfer from a first mobile device to a second mobile device. The system comprises a database for maintaining a two-dimensional matrix of a plurality of services in a first dimension of the matrix and a plurality of mobile device models in a second dimension of the matrix, and containing an indication of compatibility of a at least a service of the plurality of services to at least a mobile device model of the plurality of mobile device models; an interface for enabling communication with at least the second mobile device; a terminal connected to the interface for enabling the selection of services to be transferred from the first mobile device to the second mobile device; and a server connected to the database and to the interface and having an access to the first mobile device, the second mobile device, and the terminal through the interface, wherein the server upon receiving a request from the terminal causes transfer of services installed on the first mobile device to the second mobile device based on compatibility information stored in the table.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a system implemented in accordance with the principles of the invention.

FIG. 2 is a table of information regarding services and models of mobile devices stored in the database of the system.

FIG. 3 is a flowchart depicting the steps for exporting services from a first device to a second device in accordance with the principles of the invention.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Users of mobile devices typically load them with various services. When migrating from an old mobile device to a new one, the user is typically interested in retaining one or more of those services on the new device. Certain exemplary embodiments of the invention provides a solution enabling the effective predictive transfer or services installed on one device to another device, disabling the service on the old device and hence maintaining the rights of the user as well as of the creator of the service. If the transfer services is not possible, due for example to compatibility issues, alternative comparable services are suggested as possible replacements. Transfer of services is performed in real-time, to ensure prompt completion of the process.

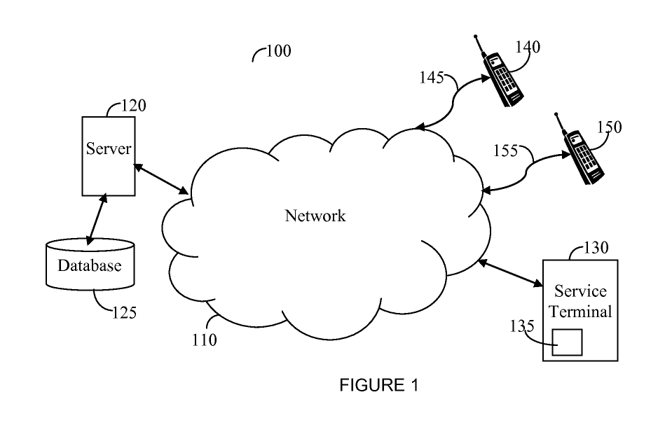

FIG. 1 shows an exemplary and non-limiting system 100 implemented in accordance with the principles of the invention. The system 100 comprises a network 110 that may include one or more communication elements including, but not limited to, a local area network (LAN), a wide area network (WAN), a metro area network (WAN), the Internet, the worldwide web (WWW), a wireless network, a cellular networks, and the like. To the network 110 there is coupled a server 120 that is coupled to a database 125. The database 125 is shown herein as being coupled to the server 120 through a dedicated communication link however this should be viewed as a mere example. In another embodiment of the invention the database 125 may be coupled to the network 110 and be communicatively coupled to the server 120.

The server 120 and the database 125 are responsible of handling information respective of services and mobile devices as further discussed herein below. A plurality of mobile devices may be communicatively coupled to the network 110. Specifically, for the purpose of illustration of the invention, a first mobile device 140 is communicatively coupled by means of a link 145 to the network 110, and a second mobile device 150 is communicatively coupled by means of a link 155 to the network 110. In one embodiment of the invention the communication over communication link 145 is performed using the mobile number of the mobile device 140, thereby avoiding the need to match a communication method to the device type. This applies similarly to communication the link 155 and mobile device 150. Other communication links are also possible including without limitation interfaces such as WiFi and BlueTooth® as well other proprietary or standard means of communication that may be applicable for the purposes described herein.

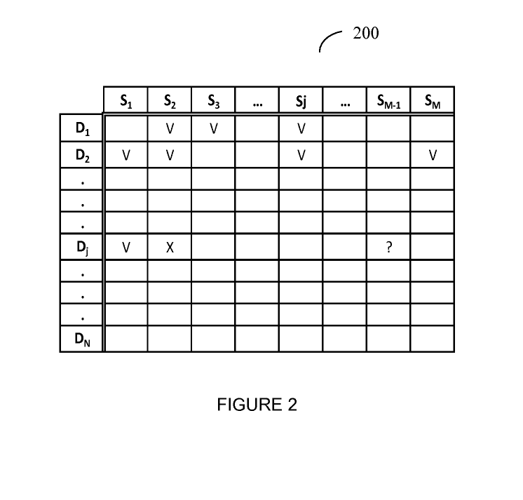

FIG. 2 shows an exemplary and non-limiting table 200 stored in the database 125. A detailed discussion of the table 200 and the method for generating this table is provided in a co-pending patent application number entitled “Apparatus And Method For Determining Compatibility Between Services And Mobile Devices” to Noam Guzman filed on Jan. 1, 2010, assigned to common assignee, and which is incorporated herein by reference for all that it contains. The table 200 is a two-dimensional matrix that comprises a number of N rows (N is an integer number equal to or greater than 1), each row representing a different mobile device model, for example mobile device model D. The table 200 further comprises for a number of M columns (M is an integer number equal to or greater than 1), each column representing a different service, for example service Sⱼ.

Due to differences between the different mobile devices D and the requirements of the different services S, not all devices D are capable of executing all services S. Therefore, the table 200 is filled out with information regarding the compatibility between a model D and a service S. For example, full compatibility may be shown as a “V”, no compatibility as an “X”, and unknown compatibility as a “?” or just left blank. Such exemplary information is shown in the table 200. Accordingly, a mobile device model D₁, is compatible with the services S₂, S₃ and Sⱼ, while model D₂ is compatible with services S₁, S₂, Sⱼ and S_{M}. Model Dᵢ is compatible with S₁, not compatible with S₂ and S₃ and has unknown compatibility with S_{M-1}. Hence, assuming a user having the services S₂ and Sⱼ installed on a mobile device model D₁ and wishing to transfer to mobile device model D₂, a lookup of the table confirms that there is compatibility and such transfer of services is possible. However, if the user's original device also had service S₃ compatibility would not be assured. In one embodiment of the invention the table 200 may include in each intersection point a ranking value that provides a compatibility ranking for the services with respect of the device. In the case where an alternate service is to be selected in lieu of an existing service, the alternate service having a higher ranking would be considered first.

In one embodiment another table (not shown) for mapping services is be stored in the database 125 containing compatibility information between different services. Such a table contains, for example, rows and columns, a row for each service and a column for each service. The services table indicates if a service is equivalent to another service, a subset of another service or a superset thereof. Using the services table it is possible to check if the other service(s) is (are) compatible with the target user mobile device model D₂ and if so suggest to the user to replace the service installed on the original mobile device with another service which is compatible, a subset or a superset thereof.

Returning to FIG. 1, a service terminal 130, for example a personal computer, coupled to the network 110, is enabled to communicatively connect to the mobile device of a user, for example, the mobile device 140 of a model D₁, equipped with services, for example S₂ and Sⱼ. The user is interested to transfer services S₂ and Sⱼ to another mobile device, for example mobile device 150, of a different model, for example model D₂ to which the service terminal 130 is further communicatively coupled to. The service terminal 130, having, for example, appropriate code stored in memory 135, checks compatibility with the server 120 and database 125, and upon validation that compatibility exists the services are enabled on the mobile device 150 and disabled on the mobile device 140. As explained above, if for example mobile device 140 also has service S₃ installed which is not shown as being compatible with mobile device 150, then it is possible to search for alternative services that are either compatible, a subset or superset of the service S₃ and offer them as an alternative to the service S₃ not known to be operative for model D₂.

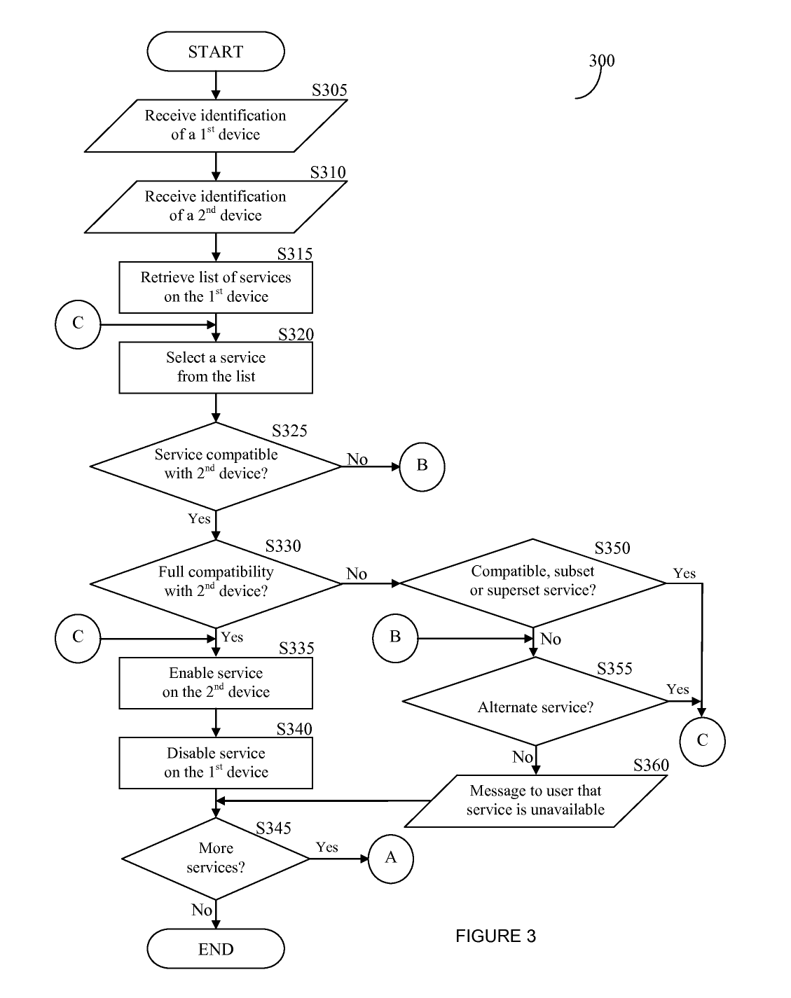

FIG. 3 depicts and exemplary and non-limiting flowchart 300 of for a method exporting services from a first device to a second device in accordance with the principles of the invention. In S305 the identification of a first mobile device, the source device, for example mobile device 140, is received. In S310 the identification of a second mobile device, for example mobile device 150, the target device, is received. In S315 a list of the services installed on the first mobile device is retrieved. In one embodiment of the invention another step is performed enabling the user of the source device to determine which of the services on the source device should be transferred to the target device.

In S320, a service is selected from the list. In S325 it is checked whether the service is compatible with the model of the target device, and if so execution continues with S330; otherwise, execution continues with S355. In S330 it is checked whether there is full compatibility, and if so execution continues with S335; otherwise, execution continues with S350. In S335 the selected service is installed on the target device using executable code that is appropriate for that device, even if different from the executable code of the source device. However, in one embodiment, of the executables are the same, the system 100, and in particularly the service 120 and terminal 130 enable the transfer of the executable from the source device to the target device. Furthermore, the server 120 may also test the version of the executable and if necessary may suggest to the user to install a newer version of the executable code of the service.

In S340, if applicable, the corresponding service is disabled on the source device. It should be noted that in some cases it is impossible to disable the service on the mobile device. In such a case the method may check the user rights on the service and may allow the installation on the target device without the disablement of the service on the source device. This may allow the user to move, for example, all the games from the source device to the target device. In one embodiment such transfer may be limited in the number of transfers, allowing, for example, a single transfer.

In S345 it is checked whether addition services are to be transferred, and if so section continues with S320; otherwise, execution terminates. In S350 it is checked whether the user wishes to install a service with partial compatibility, a subset thereof or a superset thereof. If so, upon selection of the desired service, execution continues with S335; otherwise, execution continues with S355.

In S355, it is checked whether the user is willing to install an alternate service which is similar to the service installed on the source device, and if so execution continues with S335; otherwise, execution continues with S365. It should be noted that switching to another similar, upgraded or alternate service may also include a process where the user is charged for the newer service installed. In S365, a message is sent to the user of an inability to install or provide an alternate service to the service installed on the source device and execution continues with S345.

In certain implementations of the method, it is first established which are the services to be installed on the target mobile device, and only then the full suite of selected service is installed. Other implementations are also possible without departing from the spirit of the invention. It should be noted that in some cases described hereinabove there may be a billing step involved.

In one embodiment of the invention the server 120 further checks usage of the services to be transferred. If the server 120 identifies that a service is not used by the user it may suggest the removal of the service, thereby freeing up space for potentially other services to be installed. In yet another embodiment of the invention the terminal 130 enables the transfer of the services installed on the source mobile device to the target mobile device by a single click. It should be understood that the method herein may include communication between the source mobile device and the target mobile device but it is not a requirement of the invention described herein.

In a further embodiment of the invention, the system 100 further enables the transfer, when applicable, of digital management rights (DRMs) from the source mobile device to the target mobile device, thereby maintaining such rights in good order. It should be further noted that while the system described hereinabove was described with respect of an upgrade from an available source mobile device to an available target mobile device, other modes of operation are possible.

In certain instants the source device may be unavailable due to damage, loss or theft. In such a case the source mobile device described above is unavailable. In one embodiment of the invention, the reconstruction of the services may be done from a backup that was made for the source mobile device on a periodic basis. In yet another embodiment of the invention the list of service installed on the source device is actively maintained by the server 120, for example, by storing the information in the database 125. This information may be used for the generation of the list of services and from thereon the method continues as described above. In another case, when no backup is available manual or electronic lists maybe available, as well as the user's recollection installed on the source mobile device as well as records thereof of the services. A list of these services can then be created and from thereon the method continues as described above. The teachings herein may further be used to offer the user new services or renewal of existing services determined to be relevant to such user as part of the transfer process described herein.

The principles of the invention may be implemented in hardware, firmware, software or any combination thereof. Moreover, the software is preferably implemented as an application program tangibly embodied on a program storage unit or computer readable medium. One of ordinary skill in the art would recognize that a “machine readable medium” is a medium capable of storing data and can be in a form of a digital circuit, an analogy circuit or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

1. A system for enabling service transfer from a first mobile device to a second mobile device, the system comprising:
a database for maintaining a two-dimensional matrix of a plurality of services in a first dimension of the matrix and a plurality of mobile device models in a second dimension of the matrix, and containing an indication of compatibility of a at least a service of the plurality of services to at least a mobile device model of the plurality of mobile device models;
an interface for enabling communication with at least the second mobile device;
a terminal connected to the interface for enabling the selection of services to be transferred from the first mobile device to the second mobile device; and
a server connected to the database and to the interface and having an access to the first mobile device, the second mobile device, and the terminal through the interface, wherein the server upon receiving a request from the terminal causes transfer of services installed on the first mobile device to the second mobile device based on compatibility information stored in the table.

2. The system of claim 1, further comprising an interface enabling communication with the source mobile device and the target mobile device, wherein services installed on the first mobile device are recognized by accessing the first mobile device through the interface.

3. The system of claim 1, wherein the compatibility information is utilized to identify matching services that match the services installed on the first mobile device, wherein a matching service is any of: an identical match, a comparable match, an upgrade match, and an alternate match.

4. The system of claim 1, wherein the transfer of a service includes the transfer of an executable code respective of the transferred service.

5. The system of claim 4, wherein the transfer of a service include the installation of a newer version of an executable code of the service being transferred.

6. The system of claim 1, wherein the transfer of service includes a request for an additional charge that is displayed on the terminal.

7. The system of claim 1, wherein the transfer of a service includes the transfer of at least a digital management right (DRM) from the first mobile device to the second mobile device.

8. The system of claim 1, wherein the terminal is capable of displaying to the user of the terminal the possibilities of migration of the services installed on the first mobile device to the second mobile device and accepting responses thereof.

9. The system of claim 1, wherein the terminal enables the transfer of the services installed on the first mobile device to the second mobile device in a single click.

10. The system of claim 1, wherein the transferred service is disabled on the first mobile device.

11. A method for enabling service transfer from a first mobile device to a second mobile device, comprising:
identifying the first mobile device model;
identifying the second mobile device model;
retrieving a list of services installed on the first mobile device;
accessing a two-dimensional matrix contained in a database, wherein the two-dimensional matrix includes a plurality of services in a first dimension of the matrix and a plurality of mobile device models in a second dimension of the matrix, and containing an indication of compatibility of at least one service of the plurality of services to at least a mobile device model of the plurality of mobile device models;
determining using the compatibility indication which of the services in the list of services are compatible with second mobile device; and
installing an executable code of each of the compatible service on the second mobile phone.

12. The method of claim 11, further comprising:
disabling the at least a service on the first mobile device upon successful installation on the second mobile device.

13. The method of claim 11, wherein the compatible service is a matching service to a service installed on the first mobile device, wherein a matching service is any of: an identical match, a comparable match, an upgrade match, and an alternate match.

14. The method of claim 11, further comprising:
transferring an executable code respective of the transferred service from the first mobile device to the second mobile device.

15. The method of claim 11, further comprising:
displaying a request for an additional charge from the user of the second mobile device.

16. The method of claim 11, wherein the transfer of a service includes the transfer of at least a digital management right (DRM) from the first mobile device to the second mobile device.

17. The method of claim 11, wherein the transfer of a service include the installation of a newer version of an executable code of the service being transferred.

18. The method of claim 11, further comprising:
displaying to the user of the second mobile device the possibilities of migration of the services installed on the first mobile device to the second mobile device and accepting responses thereof.

19. The method of claim 11, further comprising:
transferring the services installed on the first mobile device to the second mobile device using a single click.

20. The method of claim 11, wherein retrieving the list of services comprises retrieval of a list from a backup of the services made for the first mobile device.

21. The method of claim 11, wherein retrieving the list of services further comprises: receiving at least a service installed on the first mobile device from records respective of the first mobile device.
